(19) United States
(12) Patent Application Publication
(10) Pub. No.: US 2014/0122107 A1
(43) Pub. Date: May 1, 2014

(54) System and Method for Reporting of Medical Advice

(71) Applicant: Analyte Health, Inc., Chicago, IL (US)

(72) Inventors: Daniel Paul Malven, Chicago, IL (US); Leon Taylor Chism II, Glen Ellyn, IL (US); Vasili Michael Kolovos, Chicago, IL (US); Mark Aaron Rogers, Chicago, IL (US); Jesse Solomon London, Chicago, IL (US); Justin Charles Weber, Chicago, IL (US); Mark Robert Wise, Willobrook, IL (US); Mark Evan Aston, Elmhurst, IL (US); Lisa Keefe, Des Plaines, IL (US)

(73) Assignee: Analyte Health, Inc., Chicago, IL (US)

(21) Appl. No.: 14/063,643

(22) Filed: Oct. 25, 2013

Related U.S. Application Data
(60) Provisional application No. 61/718,671, filed on Oct. 25, 2012.

(51) Int. Cl. G06F 19/00

(52) U.S. Cl. CPC G06F 19/3487
USPC 705/2

(57) ABSTRACT

A computer-implemented system and method for reporting of medical advice are provided. Demographic information associated with a patient user, and a request from the patient user for a recommendation in connection with a medical condition are received from a first computing device. A prescription is created for a test plan associated with the medical condition and the prescription is transmitted to a second computing device associated with an entity that executes the test plan. Test results associated with execution of the test plan for the patient user are received from the second computing device. A regulations database is used to determine a delivery method for communicating the test results to the patient user. A medical report in accordance with the delivery method is generated and the medical report is transmitted to the patient user. The regulations database includes regulations associated with different jurisdictions.

### CROSS REFERENCE TO RELATED APPLICATIONS

The present application claims the benefit of Malven, et al., U.S. Provisional Patent Application Ser. No. 61/718,671, filed on Oct. 25, 2012, and having the title “SYSTEM AND METHOD FOR COORDINATING HEALTHCARE SERVICES.” The entire contents of this application are incorporated herein by reference.

### BACKGROUND OF THE DISCLOSURE

1. Field of the Disclosure

The present disclosure is directed generally to a system and method for providing healthcare services to an individual, and in particular to a system and method to coordinate acquisition of and payment for healthcare services.

2. Description of the Background of the Disclosure

An individual who notices a physical change such as, for example, a rash, pain, and/or a discharge, may want to determine if such a change warrants concern or consultation with a healthcare provider. Even if the individual does not exhibit any physical changes, the individual may be concerned if he or she has had contact with another individual who may have a contagious medical condition or has otherwise been exposed to a contagion. Additionally, an individual may learn of a new medical innovation that can detect the presence of, or pre-disposition to contract, a disease or condition, such as cancer or heart failure, earlier than was previously possible. Further, the individual may want learn of or benefit from a new procedure to treat an existing disease or condition in people with certain genetic or other individual-specific factors.

In some cases, the individual may have difficulty or may not wish to consult with the physician directly. For example, the physician's schedule may prevent the individual from obtaining a consultation in a timely fashion or the physician may not have incorporated the most relevant medical innovations into their practice yet. In addition, the individual may not wish to expend the time necessary to go to a physician's office unless necessary. Alternately, the individual may not wish to discuss his or her reasons for concern with a physician unless necessary, for example, if the concern involves a sexually transmitted disease or a behavioral disorder.

The individual may consult a medical book or an online resource such as those provided by WebMD (www.webmd.com) or Mayo Clinic (www.mayoclinic.org/health-information) to determine if an in-person consultation with a healthcare provider is warranted. However, such resources provide only generalized information that may not reflect current medical knowledge, may not address the particular symptoms or concerns of the individual, and do not take into account the specific biometric information of the individual, such as test results or other diagnostic measurements.

In some cases, an individual may not know what to do and the effort to find out, for example, by consulting a medical resource or a physician may seem too great and therefore the individual does not do anything. This causes potential damage to the individual, the individual's community and ultimately to society in terms of greater overall healthcare costs.

Healthcare in the United States is generally regulated on a state-by-state basis and requires coordination with private and/or public insurance providers. For example, procedures that are covered by an insurance provider and how claims are submitted may depend on regulations established at the state level. Further, state and federal regulations may dictate circumstances in which a physician must be involved when healthcare services are provided, and the form and content of certain physician-patient interactions. Further, a state board typically licenses and regulates physicians practicing medicine on residents of a state and, therefore, a physician licensed in one state may not be able to provide or coordinate services provided to an individual who resides in a different state. For at least these reasons, Internet based services have not yet offered comprehensive healthcare resources that take into consideration diagnostics, patient-physician communication modes, reporting, regulatory, and insurance aspects of providing such services.

### SUMMARY

A computer-implemented system for reporting of medical advice includes a patient communication engine, a prescription engine, a results analysis engine, a medical advice engine, and a reporting engine. The patient communication engine receives, from a first computing device, demographic information associated with a patient user and a request from the patient user for a recommendation in connection with a medical condition. The prescription engine creates a prescription for a test plan associated with the medical condition and transmits the prescription to a second computing device associated with an entity that executes the test plan. The results analysis engine receives from the second computing device test results associated with execution of the test plan for the patient user. The medical advice engine uses a regulations database to determine a delivery method for communicating the test results to the patient user. The regulations database includes regulations associated with different jurisdictions. The reporting engine generates a medical report in accordance with the delivery method and provides the medical report to the patient communication engine for transmission to the patient user.

A computer-implemented method for reporting of medical advice is also provided. The method includes receiving, from a first computing device, demographic information associated with a patient user and a request from the patient user for a recommendation in connection with a medical condition. The method also includes creating a prescription for a test plan associated with the medical condition, transmitting the prescription to a second computing device associated with an entity that executes the test plan, and receiving from the second computing device test results associated with execution of the test plan for the patient user. The method further includes determining, using a regulations database, a delivery method for communicating the test results to the patient user, generating a medical report in accordance with the delivery method and transmitting the medical report to the patient user. The regulations database includes regulations associated with different jurisdictions.

### BRIEF DESCRIPTION OF THE DRAWINGS

FIGS. 1A and 1B are block diagrams of a system for coordinating healthcare services that is used by physician users, patients of those physician users, and prospective patients of those physician users;

FIG. 2 is a flowchart of processing undertaken by the system of FIGS. 1A and 1B for the coordination of healthcare services;

FIGS. 3A and 3B are a flowchart of processing undertaken by the system of FIGS. 1A and 1B to qualify prospective patient users as candidate patient users;

FIG. 4 is a flowchart of processing undertaken by the system of FIGS. 1A and 1B to determine what services a physician user should provide to a patient user;

FIGS. 5, 6A, and 6B are flowcharts of processing undertaken by the system of FIGS. 1A and 1B to generate a medical report for the physician user to provide to a patient user;

FIGS. 7 and 8 are flowcharts of processing undertaken by the system of FIGS. 1A and 1B to collect payment for services rendered; and

FIGS. 9A and 9B illustrate pages of an example medical report that may be generated by the system of FIGS. 1A and 1B.

### DETAILED DESCRIPTION

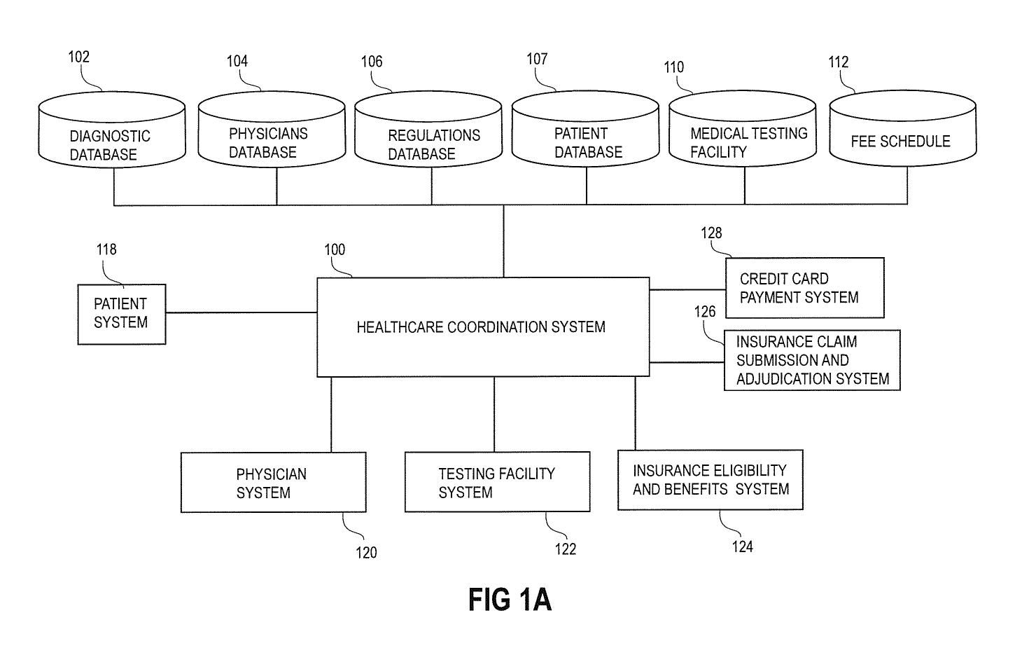

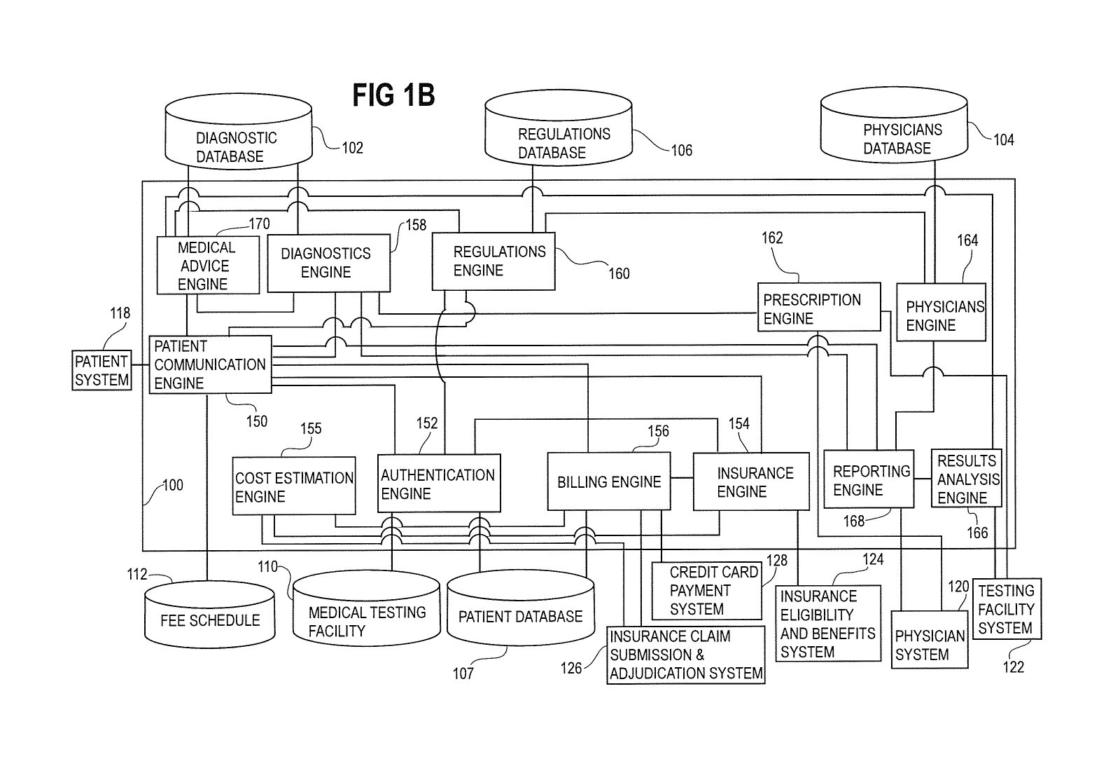

Referring to FIG. 1A, a healthcare coordination system (HCS) 100 accesses information stored in a diagnostics database 102, a physicians database 104, a regulations database 106, a patient database 107, a medical testing facility database 110, and a fee schedule database 112. In addition, the HCS 100 communicates with computer-based systems 118, 120, and 122 associated with a patient, a physician, and a testing facility, respectively. The HCS 100 also communicates with an insurance eligibility and benefits system 124, an insurance claim submission and adjudication system 126, and a credit card payment system 128. Typically, the patient system 118 is a computer, a mobile communications device, or other computing device and the HCS 100 communicates with such system 118 over a public network such as the Internet. Similarly, the physician system 120, the medical test facility system 122, the insurance submission and adjudication system 124, the insurance claim submission and adjudication system 126, and the credit card payment system 128 are also computers, mobile communication devices, or other computing devices and the HCS 100 communicates with such systems over a public or private network. The HCS 100 and the systems 118, 120, 122, 124, 126, and 128 may also operate over a cellular network or other communication networks apparent to those of skill in the art. In one example embodiment, communications between the patient system 118 and the HCS 100 use a secure communication protocol such as, for example, HTTPS.

The diagnostics database 102 stores questions associated with medical symptoms and patient user behaviors. For each question, the diagnostics database 102 stores possible responses to such question. For each possible response, the diagnostics database 102 stores a link to one or more further questions to present to the patient user to obtain more information, or a link to a medical test that should be added to or removed from a test panel recommended to the patient user. In addition, the diagnostics database 102 includes, for each medical test, data regarding a sample to collect from the patient user and different ways in which such sample may be collected. For each question, the diagnostics database 102 may include the exact text present to the patient user for such question. In addition, the diagnostics database 102 may have multiple versions of such text for each question, and a diagnostics engine 158 of the HCS 100, FIG. 1B, may select a particular version of the question depending on characteristics of the patient user. For example, for a particular question, the diagnostics database 102, FIG. 1A, may have stored therein a version to be presented to a male patient user, a version to be presented to a female patient user, a returning patient user, a new patient user, and the like.

The diagnostics database 102 also stores information regarding medical conditions and identifies a group of tests (a condition group) that may be used to diagnose a particular medical condition.

The diagnostics database 102 also stores information regarding test results. For each test specified in the diagnostics database 102, the diagnostics database 102 stores possible results of such test. For each result, the diagnostics database 102 includes an indication of whether such result is a normal result, or an abnormal result.

In some cases, the diagnostics database 102 may include test results for a combination of tests in a condition group. The combined test results may indicate that the patient user may have a medical condition associated with the condition group.

The regulations database 106 stores information regarding federal and state regulations that dictate how medical information may be communicated to a prospective patient user or patient user. Such regulations include those enacted by state medical boards or other state and/or federal agencies that govern a patient-doctor relationship or how medical services may be provided. In one embodiment, each regulation is encoded in the regulations database 106 as an assertion of a regulation. The regulations database 106 also includes an indication of an association between each assertion and the states in which the assertion is valid. For example, the regulations may include an assertion “advice must be delivered by physician” and an indication of an association between such assertion and the states of, for example, Illinois, Indiana, Texas, and the like. Other assertions may include “allow treatment by telemedicine,” “allow online ordering of medical services,” and the like. It should be apparent to those of skill in the art that such assertions are encoded in the regulations database 106 in a manner usable by a computer system. Similarly, it should be apparent to those of skill in the art that the indications of associations between assertions and states are encoded in the regulations database 106 in a manner usable by a computer system.

The physicians database 104 stores information about physician practice groups and physician users. For each physician user, the physicians database 104 may include identification information (name, address, telephone number, and the like), insurance plans that cover the physician user, the practice group, if any, with which the physician user is affiliated, medical practice areas of the physician user, and jurisdiction(s) in which the physician user is licensed to practice. The physicians database 104 may also include business arrangements between the operator of the HCS system 100 and the physician user such as a percent of patient users in the physicians jurisdiction that will be referred to such physician.

A medical testing facility database 110 includes identifying information about entities that may administer medical tests. The medical testing facility database 110 includes identifying information about the entity including locations where the entity operates, tests the facility administers, and the insurance plans that will pay for services provided by the entity. Further, for each test administered by the entity, the medical testing facility database includes one or more codes associated with the entity for such test, one or more samples required for such tests, and sample collection methods that may be used to provide the one or more samples to the entity. In addition, the testing facility includes information specific to the entity that needs to be specified on a prescription submitted to such entity.

Prospective patient users and patient users use the patient system 118 to access the HCS 100 using a web site or mobile device application server operated on the HCS 100. In one embodiment, the web site or mobile device application server may be associated with a particular type of healthcare procedure. For instance, the HCS 100 may host separate web sites or mobile device application servers and each such web site or application server coordinates services associated with a particular medical condition or particular types of medical conditions. For example, separate web sites or mobile device application servers may be created for medical conditions associated with sexually transmitted diseases (STDs), children's ailments, stress related diseases, and the like. Each such web site may have a unique Uniform Resource Locator (URL) or mobile device application associated therewith and the prospective patient user and patient user uses such URL or application to access the web site or application server. The HCS 100 uses the URL or application used by such users to identify the medical condition for which such users should be offered services. In addition, the HCS 100 may operate a portal web site or master application that includes hyperlinks with URLs for the separate web sites or application servers.

The HCS 100 includes a number of engines that operate to coordinate medical services provided to an individual. It will be understood and appreciated that such engines may include hardware, software, or a combination of hardware and software. The software may be stored in a non-transitory computer-readable storage medium and include an ordered listing of executable instructions that may be executed within a processing module or controller, which includes, for example, one or more microprocessors, general purpose processors, combinations of processors, digital signal processors (DSPs), field programmable gate arrays (FPGAs), or application-specific integrated circuits (ASICs). The example systems, engines, and databases described in this application may be implemented in a variety of configurations and operate as hardware/software components in a single hardware/software unit, or in separate hardware/software units.

A patient communication engine 150 generates a user interface that is displayed on the patient system 118 used by a prospective patient user. The user interface allows the prospective patient user to provide demographic and insurance information. In some embodiments the user interface is an electronic form that the prospective patient user completes and submits to the patient communication engine 150. An insurance engine 154 transmits the insurance information to an insurance eligibility and benefits engine 124 to verify the insurance status of the prospective patient user.

Referring to FIG. 1B, a patient communication engine 150 generates another user interface for display on the patient system 118 that allows the prospective patient user to enter subjective information including why the prospective patient user wishes to receive medical services associated with a medical condition. Such subjective information includes a chief complaint and history of present illness (HPI) including symptoms, medical and behavioral histories, and other possible indicators associated with the medical condition.

A physicians engine 164 identifies a physician user from the physicians database 104 to associated with the prospective patient user. The physician user is identified in accordance with one or more regulations of a jurisdiction where the prospective patient user resides, the medical condition for which medical services are desired, and the insurance information provided by the patient user.

A regulations engine 160 analyzes the data stored in the regulations database 106 to determine if a patient-physician relationship is necessary in the jurisdiction where the patient user resides. If such a patient-physician relationship is necessary, the regulations engine 160 generates and presents, via the patient communications engine 150, a legally binding service agreement to the prospective patient user. If the prospective patient user agrees to the legally binding service agreement or if no agreement is necessary, the regulations engine 160 notes that the prospective patient user is a patient user has accepted the legally binding service agreement or that such an agreement is not necessary. If the patient user does not agree to the legally binding service agreement the HCS 100 exits.

The diagnostics engine 158 then uses the diagnostics database 102 to develop a series of questions to present to the patient user via the patient communication engine 150. As described further below, the responses to such questions are used to identify one or more candidate medical conditions the patient user may have contracted. In addition, the diagnostics engine 158 uses the diagnostics database 102 to develop a test plan that may be used to verify whether the patient user has contracted any of the one or more medical conditions.

A cost estimation engine 155 analyzes the test plan and the insurance information provided by the patient user to develop an estimate of fees the patient user may need to pay. If the patient user agrees to pay the fees, a prescription engine 162 creates a prescription in accordance with the test plan. The prescription is transmitted to an entity that will execute the test plan. The entity is selected in accordance with the information stored in the medical testing facility database 110, the tests specified in the test plan, and the demographic and/or insurance information provided by the patient user.

A results analysis engine 166 receives the results of the tests in test plan and the diagnostics database 102 to determine whether the results are normal or abnormal. A medical advice engine 170 develops medical advice to present to the patient user and determines whether the physician user needs to directly present to the patient user such medical advice. A reporting engine 168 develops a report in accordance with the test plan and the medical advice, and provides the medical report to the patient via the patient system 118 and/or physician user via the physician system 120.

A billing engine 156 generates and submits a claim to an insurance claim submission and adjudication system 126 to obtain, from the insurance provider associated with the patient user, payment for the medical service fees covered by insurance. The billing engine 156 submits an invoice to a payment system 128 associated with the patient user to obtain payment for the portion of fees not covered by insurance.

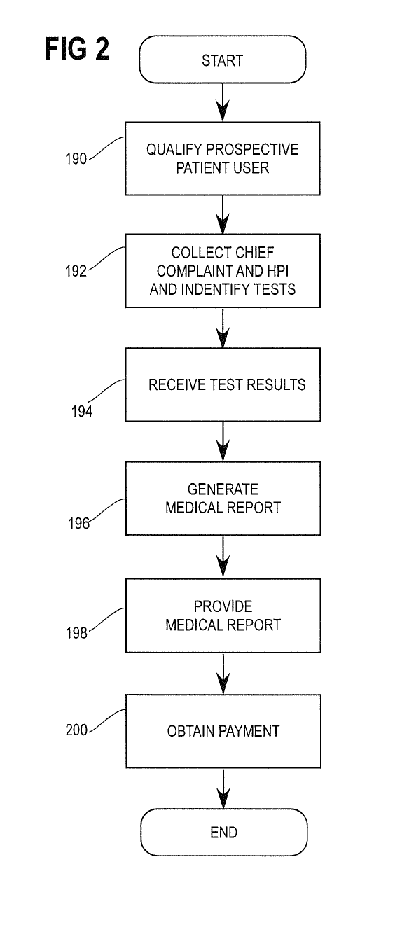

FIG. 2 is a flowchart of processing undertaken by the HCS 100. At block 190, the HCS 100 obtains demographic information including identifying information and insurance information from the prospective patient user. The HCS 100 transmits such information to the insurance eligibility and benefits system 124 to determine the prospective patient user's insurance plan status and benefits levels, which in turn determine an estimate of the division of fees for the medical service between the prospective patient user and an insurance provider associated therewith. The HCS 100 then, at block 192, obtains subjective information from the prospective patient user including any reasons why the prospective patient user wants to receive services from a physician user. Such subjective information includes a chief complaint and history of present illness (HPI) including symptoms, medical and behavioral histories, and other possible indicators associated with the medical condition. Such information is analyzed in accordance with information stored in the diagnostics database 102 to develop a medical test plan that should be administered to the patient user. The medical test plan includes a test panel that comprises one or more tests to administer to the patient user. In addition, for each test, the test plan may identify one or more samples associated with the tests to collect from the patient user and how such samples should be collected. For example, the patient user may be sent a collection device with instructions for collecting the sample and how to return the collection device with the sample. Alternately, the patient user may be directed to a testing entity where the sample may be collected. The HCS 100 also queries the medical testing facility database 110 to identify one or more testing facilities that would be convenient for the patient user. The HCS 100 coordinates generation of a prescription (from a physician user, if necessary) for administering the medical tests to the patient user. Such prescription is generated in accordance with the responses provided by the patient user and regulations stored in the regulations database 106. The HCS 100 obtains from the patient user a selection of a testing facility from the identified testing facilities to administer the medical tests. The prescription is provided to the patient user and transmitted to the selected testing facility system 122.

At block 194, the HCS 100 receives objective information from the testing facility system 122 including results of the test panel administered to the patient user. At block 196, the HCS 100 analyzes the subjective and objective information and develops a medical report. The medical report includes a summary of the test results and a medical recommendation or plan for a follow up consultation associated with chief complaint, history of present illness, and test results. At block 198, HCS 100 transmits the medical report to the patient user, the physician user, or both in accordance with the medical recommendation and state and federal regulations. In some circumstances, the HCS 100 may transmit the medical report to the physician user to enable the physician user to verbally deliver the results to the patient user. At block 200, the HCS 100 generates and submits a claim to the insurance provider for the insurance provider's portion of the fees associated with determining the tests that should be administered and administering such tests. Similarly, the HCS 100 charges the patient user for his or her portion of such fees.

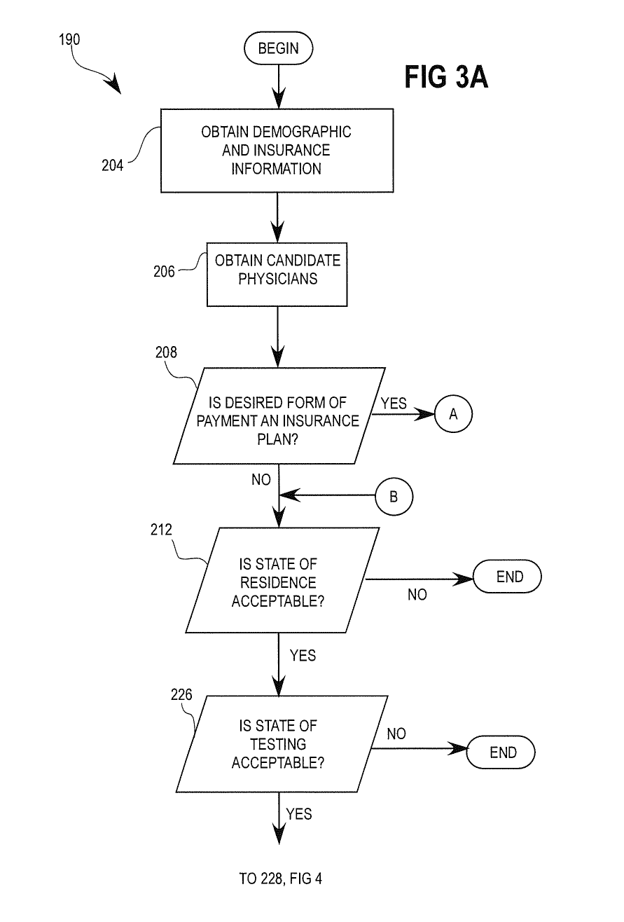

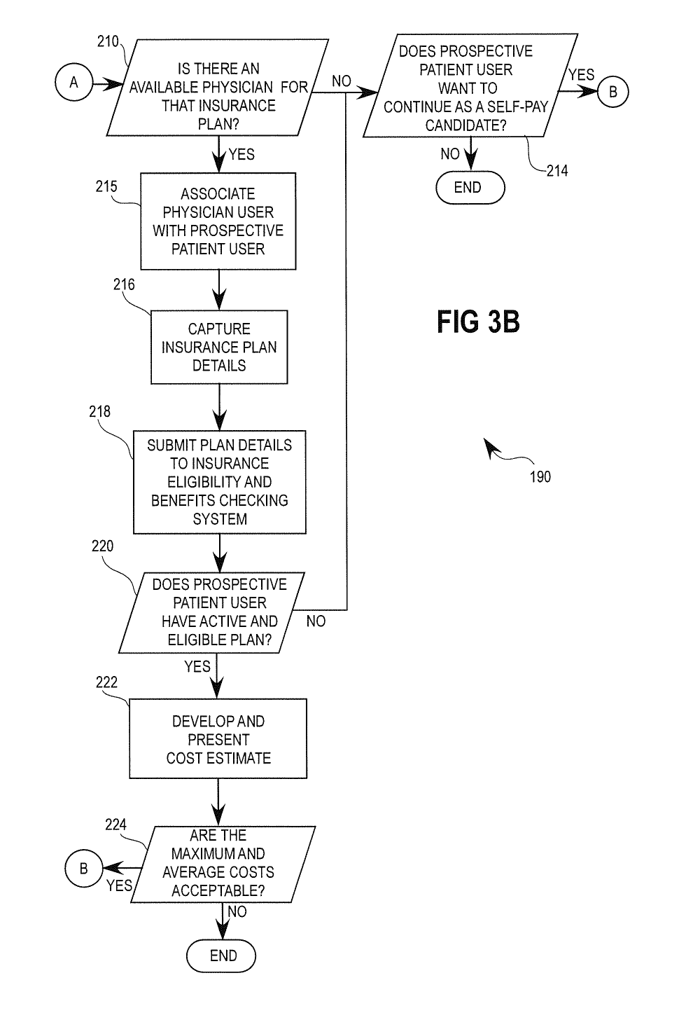

FIGS. 3A and 3B are a flowchart of processing to qualify a prospective patient user undertaken by an exemplary embodiment of the HCS 100, at block 190 of FIG. 2. Referring to FIGS. 1B, 3A and 3B, the patient communication engine 150 transmits to the patient system 118 a login page associated with a web site requested by a prospective patient user. In some embodiments the patient communication engine 150 is a web server. In other embodiments, the patient communication engine 150 is an application server that provides data to an application operating on the patient system 118. In still other embodiments, the patient communication engine 150 controls a script used by a call center operator to communicate with the prospective patient or patient user. Other types of patient communication engines 150 will be apparent to ones skilled art.

The patient communications engine 150 consults the regulations database 106 as necessary to ensure the communication with the prospective patient user or patient user complies with such regulations.

The patient communication engine 150, at block 204, FIG. 2A, obtains demographic information and insurance information from the prospective patient user. The demographic information includes identifying information such as a name and an address of residence of the prospective patient user, and desired state in which the prospective patient user would like to have medical tests conducted. The patient communication engine 150 provides the demographic and insurance information collected at block 204 to the authentication engine 152. In some embodiments, the patient communication engine 150 may require the prospective patient user to select a user name and a password that may be used to identify the prospective patient user in subsequent uses of the HCS 100, also at block 204.

The insurance information includes the name of an insurance provider, a member identifier associated with the prospective patient user, the type of insurance plan (e.g., HMO, PPO, POS, etc.), and the like. The authentication engine 152 stores the information obtained at block 204 in a record associated with the prospective patient user in the patient database 107. Processing then proceeds to block 206.

The physicians engine 164, at block 206, identifies one or more candidate physicians in the physicians database 104 who can provide services to the prospective patient user in accordance with the state where the prospective patient user resides and the state where the prospective patient user wishes to have tests administered. The physicians engine 164, also at block 206, uses the regulations engine 160 to insure that the identification of one or more candidate physician users is in accordance with any applicable state and federal regulations in the regulations database 106.

In one embodiment, the physicians engine 164 queries the physicians database 104 to identify one or more candidate physicians or physicians practice groups who are qualified to practice in the state where the user resides.

At block 208, the insurance engine 154 determines if the prospective patient user would like to have an insurance provider associated therewith billed for services. If so, the HCS 100 proceeds to block 210, otherwise the HCS 100 proceeds to block 212.

At block 210, the physicians engine 164 determines if any of the candidate physician users identified at block 206 are associated with the prospective patient user's insurance plan. If there is no such candidate physician user is found, processing proceeds to a block 214, at which the authentication engine 152 determines if the prospective patient user wants to self-pay for any services. If so, a physician user is selected for the patient user and then processing proceeds to block 212, otherwise the HCS 100 exits.

If at block 210, the physicians engine 164 determines at least one of the identified physician users is associated with the prospective patient user's insurance plan, the physicians engine 164, at block 215, selects one of the identified candidate physician users to associate with the prospective patient user. Thereafter, the authentication engine 152, at block 216, obtains additional details regarding the prospective patient user's insurance plan. Such details may include the specific plan to which the prospective patient user subscribes, a group number associated with the plan, the name of the primary member of the plan (for example, if the prospective patient user is a dependent of the primary member), and the like.

In one embodiment, the physicians database 104 includes allocation information for physicians who all practice in a particular jurisdiction. For example, such allocation information may indicate that 40-percent of patient users in the particular state are to be allocated to a first physician, and 60-percent of patient users in the particular state are to be allocated to a second physician. In such an embodiment, the physicians engine 164, at block 215 selects a physician user to associate with the patient user in accordance with such allocation. Such allocations may be predetermined based on agreements with physicians or physicians groups and/or economic factors.

The insurance engine 154 then, at block 218, transmits the insurance information and the type of service associated with the web site or mobile application accessed by the prospective patient user to the insurance eligibility and benefits system 124 to validate the insurance information and determine what portion of the fees associated with the service will be paid by the insurance provider. In response, the insurance engine 154 receives from the insurance eligibility and benefits system 124 data that indicates whether the insurance provider will fully, partially, or not cover the service provided by the physician user, at block 218.

If at block 220, the insurance engine 154 determines that the insurance provider will not pay for any services, processing proceeds to block 214, otherwise, processing proceeds to block 222.

In some example embodiments, the data received by the insurance engine 154, at block 218, from the insurance eligibility and benefits system 124 indicates the status prospective patient user's insurance plan (e.g., whether such insurance plan is active), specific benefit levels provided by such plan (including coverage types, co-pays, deductibles and the like), and applicable plan contract obligations.

In some example embodiments, if there is no response from the insurance eligibility and benefits system 124 within a predetermined period of time at block 218, the insurance engine 154 assumes eligibility of the prospective patient user based on the insurance information provided thereby at block 216. In one embodiment, the insurance engine 154 waits between 1 and 3 minutes for a response from the insurance eligibility and benefits system 124.

In other example embodiments, the insurance engine 154 may not undertake the actions at block 218 if the HCS 100 determines that response time from the insurance eligibility and benefits system 124 is too slow or such system is otherwise unavailable. In such cases, the insurance engine 154 assumes the insurance eligibility of the prospective patient user based on the insurance information provided at block 216.

In some embodiments, the insurance eligibility and benefits system 124 may be a practice management system. In other embodiments, the insurance eligibility and benefits system 124 may use a revenue cycle management system, an insurance gateway, or clearinghouse. Example insurance eligibility and benefits systems 124 include RealMed, AdvancedMD, Greenway Medical, Practice Fusion, and Emdeon. In some cases, the insurance eligibility and benefits system 124 may transmit the information provided thereto by the HCS 100 to a system operated by an insurance company associated with the prospective patient user. In some embodiments, communication between HCS 100 and the insurance eligibility and benefits system 124 is undertaken using a secure protocol over the Internet. In other embodiments, such communication is undertaken using a proprietary network. In an example embodiment, the data communicated between the HCS 100 and the insurance eligibility and benefits systems is in accordance with the ASC X12N EDI Transaction Standard. In some cases, the data is in accordance with sets 270 and 271 of such standard.

At block 222, the cost estimation engine 155 analyzes the data received at block 218 and information in the fee schedule database 112 to develop a maximum cost for services. Such maximum cost estimate includes an estimate of a maximum amount that the prospective patient user may have to pay out-of-pocket. The fee schedule database 112 includes, for each type of service provided by the HCS 100, one or more of a published fee to be charged for the service, a self-pay fee to be charged, and fees that may be charged to particular insurance providers in accordance with plans associated with such providers. To develop the general cost estimate, the cost estimating engine 155 may evaluate the information in the fee schedule database 112 and the data received from the insurance eligibility and benefits system 124 in accordance with the state where the prospective patient user resides, the state where services may be provided, laws and regulations of such states, the prospective patient user's desire to submit claims to their insurance plan, insurance network agreements of available physician users, and contractual obligations and allowable fee schedules associated with such agreements. In one embodiment, the cost estimation engine 155, at block 222, may transmit to the insurance eligibility and benefits system 124 the insurance information of the patient user, the physician user, and insurance codes described below associated with the services to be provided to the prospective patient user. In response, the insurance eligibility and benefits system 124 transmits to the cost estimation engine 155 estimated costs to the prospective patient user for the services.

In some embodiments, the cost estimation engine 155 transmits information to and receives the estimated costs from the insurance eligibility and benefits system 124 using an application programming interface (API) associated with the insurance eligibility and benefits system 124. In other embodiments, the cost estimation engine 155 automatically completes and submits an electronic form, for example, on a web site associated with the insurance eligibility and benefits system 124 and analyzes data associated with results (e.g., a web page) generated in response to such submission.

In some embodiments, the cost estimation engine 155 may use predictive analytics to develop the general or average cost estimate. In such embodiments, the cost estimation engine 155 includes historical data regarding costs associated with particular procedures and the portion of such costs that were paid by particular insurance plans. The cost estimations engine 155 maps the insurance information associated with the patient user and the services to be provided to the patient user against such historical data to develop the general cost estimate.

At block 222, the cost estimations engine 155 provides, via the patient communication engine 150, the maximum cost estimate, the estimate received from insurance eligibility and benefits system 125, and or the general cost estimate to the patient system 118.

At block 224, the patient communication engine 150, obtains authorization from the prospective patient user to continue. If the prospective patient user provides authorization to continue processing proceeds to block 212. Otherwise, the HCS 100 exits.

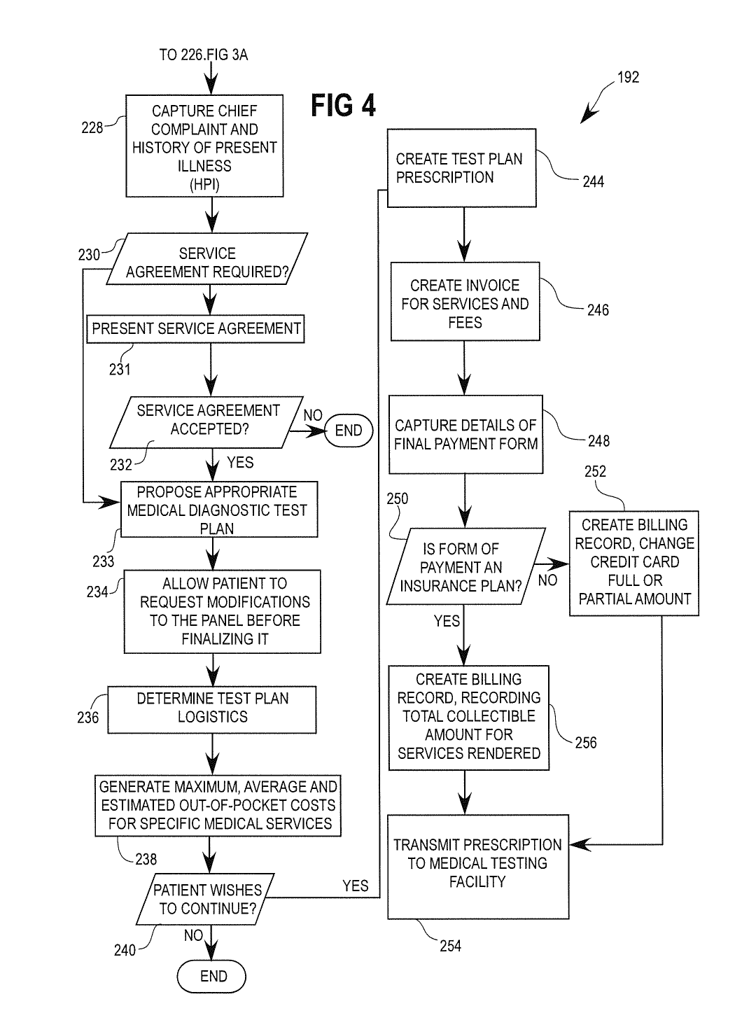

At block 212, the authentication engine 152 uses the regulations engine 160 to determine if the state where the prospective patient user resides is acceptable for the type of services desired by the prospective patient user. For example, the authentication engine 152 may determine the state to be acceptable if the HCS 100 is authorized in such state or telemedicine providers are allowed to operate in the state in accordance with the regulations thereof. If not, the HCS 100 exits. Otherwise, at block 226, the authentication engine 152 uses the regulations engine 160 to determine if the state in which tests may be provided is acceptable and if such state is not acceptable, the HCS 100 exits. Otherwise processing proceeds to block 228, FIG. 4.

FIG. 4 is a flowchart of processing an exemplary embodiment of the HCS 100 undertakes at block 192 of FIG. 2 to collect subjective medical information. Referring to FIG. 1B and FIG. 4, at block 228, the diagnostics engine 158 obtains from the prospective patient user a chief complaint and a history of present illness.

At block 230, the physicians engine 164 uses the regulations engine 160 to determine if a service agreement, for example, a patient-physician relationship agreement, is necessary in accordance with the state and federal regulations in the regulations database 106 that apply to the patient user. In some embodiments, such service agreement may be between the patient user and the physician user. In other embodiments, such service agreement may be between the patient user and an organization (e.g., a medical group) with which the physician user is affiliated. If such a service agreement is necessary, the regulations engine 160, at block 231, creates a legally binding service agreement between the patient user and one of the physician users identified at blocks 206 and/or 210 and presents the legally binding service agreement to the patient user via the patient communication engine 150. The prospective patient user is then asked, at block 232, to accept or decline the agreement. If the prospective patient user accepts the agreement, the regulations engine 160, still at block 232, notes that the prospective patient user is a patient user who has accepted the service agreement in the patient database 107 in a record associated with the patient user, and proceeds to block 233. If the patient user declines the agreement, the HCS 100 exits.

If the physicians engine 164, at block 230, determines that patient-physician relationship agreement is not necessary, the regulations engine 160 notes that a service agreement is not necessary for the patient user in the patient database 107 and processing proceeds to block 233.

At block 233, the diagnostics engine 158 identifies candidate medical conditions the patient user may have contracted and develops a proposed medical diagnostic test plan. In particular, the diagnostics engine 158 generates and presents to the patient user via the patient communication engine 150 one or more questions related to the medical service associated with the web site or application accessed by the patient user, at block 228. Such questions may be related to the patient user's medical and behavioral history, specific symptoms noticed by the patient, the medical and/or behavioral history of others with whom the patient user has had contact, and the like. At block 233, the diagnostics engine 158 uses a rules engine and such rules to filter answers provided by the patient user to identify candidate medical conditions the patient user may have contracted. If several such medical conditions are identified, the rules engine may generate further questions to reduce the number of candidate medical conditions. If the rules engine determines that further questions are not necessary, the diagnostics engine 158, at block 233, retrieves from the diagnostics database 102 medical tests associated with any remaining candidate medical conditions that should be administered to the patient user to determine whether the patient user has contracted any such medical conditions. Also at block 233, the diagnostics engine 158 develops a test plan that includes the test panel of medical tests, samples that need to be collected to administer the medical tests, and how such samples may be collected. In some embodiments, if the data in the diagnostics database 102 indicates that a sample may be collected in more than one way, the test plan includes cost information for each way in which the sample may be collected.

Thereafter, at block 234, FIG. 4, the patient communication engine 150 presents the proposed medical test plan including the identified medical tests to the patient user and how samples for such medical tests may be collected. In some embodiments, the patient communication engine 150, at block 234, allows the patient user to request the removal of some of the identified medical tests or the addition of other medical tests. The patient communication engine 150 may require the patient user to provide reasons for removing or adding medical tests at block 234. Further, in some embodiments, if the patient user removes a medical test, the patient communication engine 150 may notify the patient user that removing the medical test is contrary to medical advice and allow the patient user to re-instate the medical test. The patient communication engine 150, also at block 234, may present to the patient a list of the samples to be collected and any choices for how such samples are to be collected and costs associated with such choices. The patient user may be provided an opportunity to indicate which sample collection method the patient user wishes to use. Thereafter, at block 236, FIG. 4, the prescription engine 162 develops logistics for carrying out the test plan and, for example, queries the medical testing facility database 110 to identify one or more testing facilities that are able to provide the tests identified by the diagnostics engine 158 and that are in the state or region the patient user indicated at block 204 would be convenient thereto.

At block 238, the cost estimation engine 155 evaluates the tests determined by the diagnostics engine 158, information in the fee schedule database 112, the selected mode, and the location of sample collection, and insurance information associated with the patient user to generate maximum, average, and/or estimated out-of-pocket costs the patient user may have to pay for the tests identified at block 232 and as modified at block 234.

At block 240, the patient communication system 150 provides the costs developed at block 238 to the patient user via the patient system 118 and obtains an indication from the patient user that he or she wants to continue. If the patient user wants to continue, processing proceeds to block 244. Otherwise the HCS 100 exits.

At block 244, the prescription engine 162 creates a test plan prescription. Such prescription identifies the tests to be administered and the facility where such tests are to be provided. The test plan prescription specifies the tests to be conducted using the codes specific to an individual facility and the additional information necessary to submit the test plan prescription. In some embodiments, the test plan prescription may specify that particular specimen collection materials be sent to the patient user and materials the patient user may use to submit a collected specimen to the testing facility. Further, the prescription engine 162 may create more than one test plan prescription for the test plan if the test plan includes tests that have to be provided by more than one testing facility.

At block 246, the billing engine 156 generates an invoice for professional services and laboratory fees associated with the services provided by the HCS 100 to determine tests to be performed and anticipated charges from the medical testing facility. At block 248, the billing engine 156 presents the invoice to the patient user using the patient communication engine 150 and obtains information regarding how (e.g., credit card information, Paypal account, and the like) the patient user wishes to pay for any self-pay portion of the invoice. At block 250, the billing engine 156, determines if the patient user is responsible for paying the invoice amount. If so, the billing engine 156 generates and submits a bill for such to the credit card payment system 128 at block 252 and processing continues at block 254. If the patient user is not expected to pay the entire portion of the invoice amount, the billing engine 156, at block 256, generates and stores in the patient database 107 a billing record that includes one or more Current Procedural Terminology (CPT) codes associated with patient intake, diagnosis, laboratory services and a predetermined charge associated with each such code. The CPT code set includes codes maintained by the American Medical Association for communication of information about medical services between providers and payers of medical services. It should be apparent that the HCS 100 may use other coding systems apparent to those of skill in the art.

At block 254, the prescription engine 162 submits the test plan prescription to the testing facility system 122 associated with the testing facility identified at block 236.

In some embodiments, the prescription engine 162 may also present to the patient user via the patient communication engine 150 a prescription that may be used at such facility, at block 254. In some embodiments, the patient communication engine 150 may also schedule an appointment for the patient user at the testing facility. Further, if indicated in the test plan, the patient communication engine 150 may arrange transportation or other assistance to get the patient user's sample to the identified testing facility.

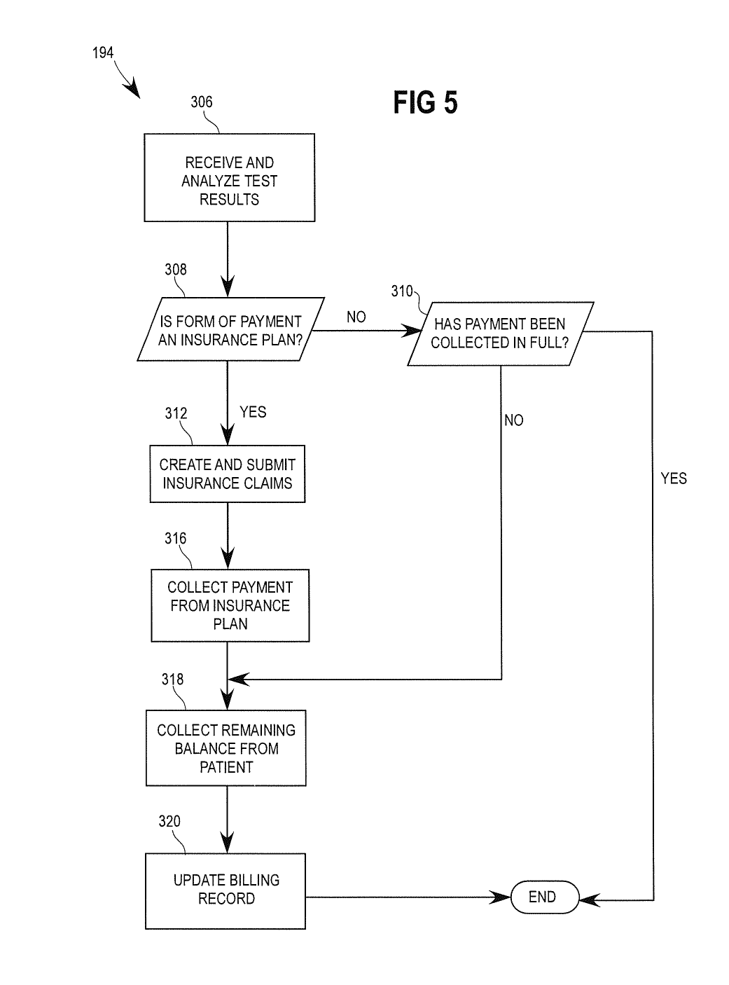

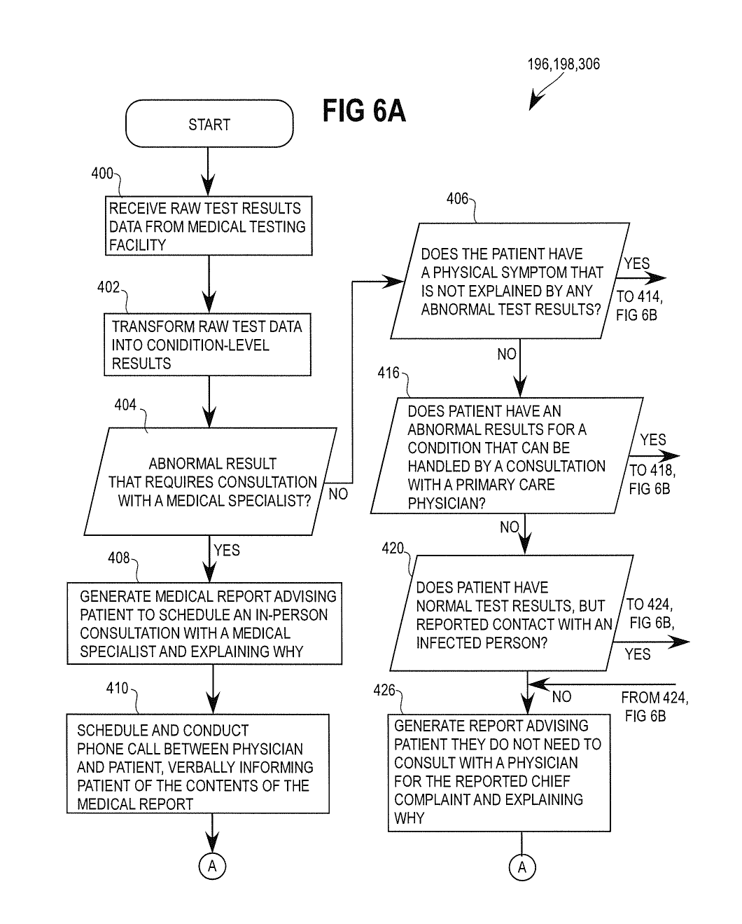

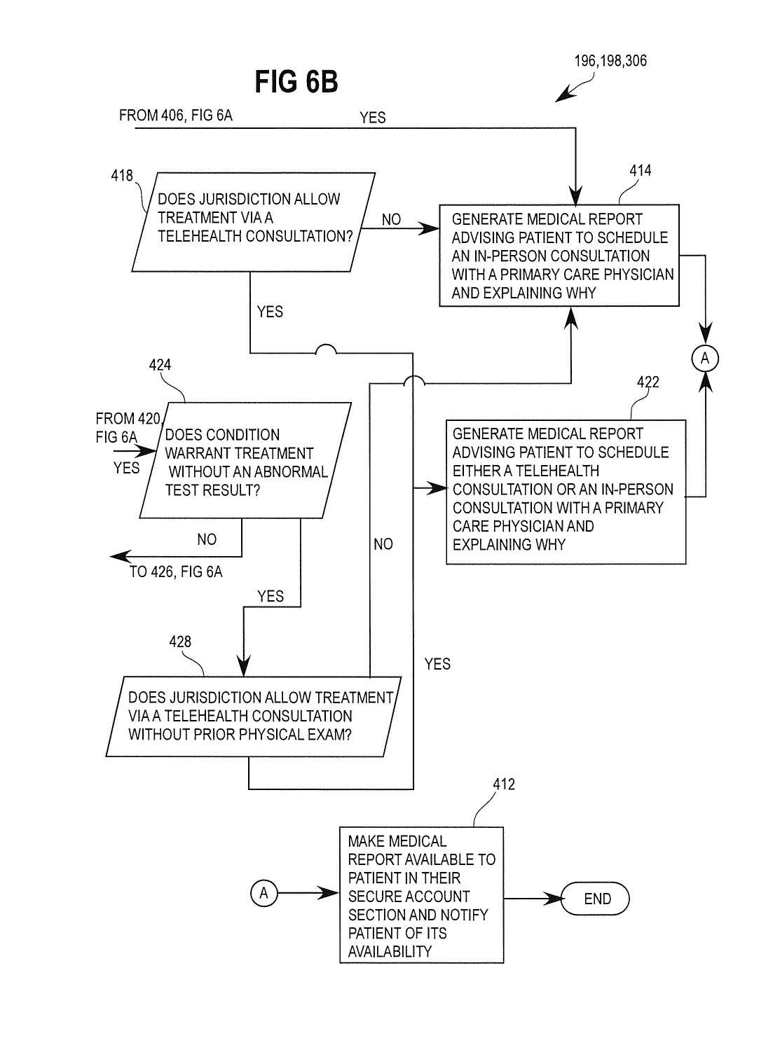

FIGS. 5, 6A, and 6B are flowcharts of processing undertaken by an exemplary embodiment of the HCS 100 at blocks 194 and 196 of FIG. 2 to receive test results, analyze such objective information in accordance with the subjective information provided by the patient user, and generate a medical report. Referring to FIGS. 1B, 5, 6A, and 6B, at block 306, the HCS 100 receives from the testing facility system 122 data associated with the results of the test panel administered to the patient user and generates the medical report. At block 308, the billing engine 156 checks if a claim is to be submitted to the insurance provider associated with the patient user and, if not, processing proceeds to a block 310. Otherwise processing proceeds to block 312. At block 310, the billing engine 156 determines if any portion of the invoice for which the patient user is responsible remains. In one embodiment, the billing engine 156 develops and submits to the insurance claim submission and adjudication system 126. In response the insurance claim submission and adjudication system 126 transmits to the billing engine 156 an adjudication of the claim that indicates the portion of the claim that will be paid by the insurance provide and the amount that can be collected from the patient user.

If a portion remains to be paid by the patient user, the billing engine 156 proceeds to block 318 and collects the remaining balance from the patient user by submitting a charge to the credit card payment system 128 and, at block 320, updates the billing record in the patient database 107 accordingly. Thereafter, the HCS 100 exits.

If at block 310, the billing engine 156 determines that payment from the patient user has been collected in full, the HCS 100 exits. Otherwise, processing proceeds to the block 318.

If at block 308, the billing engine 156 determines that payment is to be submitted to the insurance provider, the billing engine 156 creates and submits one or more insurance claim to the insurance claim submission and adjudication system 126 in accordance with the billing record created at block 256.

At block 316, the billing engine 156 receives payment from the insurance provider. If any portion of the invoice remains after payment by the insurance provider, the billing engine 156, at block 318, collects the remaining balance from the patient, for example, by submitting a charge for such remaining balance to the credit and payment system 128 to charge the payment method specified by the patient user at block 248, FIG. 2B. Thereafter, the billing engine 156 updates the billing record associated with the patient user in the patient database 107 at block 318 and the HCS 100 exits.

FIGS. 6A and 6B are a flowchart of the processing undertaken at block 306 by an exemplary embodiment of the HCS 100 to analyze and report test results. A results analysis engine 166, at block 400, receives raw test result data from the medical testing facility. In one embodiment, the testing facility system 122 transmits the test results in accordance with the HL7 Standard maintained by Health Level Seven, Inc. of Ann Arbor, Mich. At block 402, the result analysis engine 166 transforms the raw data into condition level test data. In particular, the results analysis 166 engine aggregates the test results into condition groups and classifies the results associated with each such group as normal or abnormal, at block 402. The results analysis engine 166 uses the rules in the diagnostics database 102 to determine which tests correspond to a particular condition group and how to determine if a test result should be classified as normal or abnormal.

At block 403, the medical advice engine 170 analyzes responses to queries supplied by the patient user, the demographic information supplied by the patient user, and the test results to develop medical advice that should be provided to the patient user via patient system 118. For example, if the test results are normal and the patient user did not indicate experiencing any symptoms in the responses, the medical advice developed by the medical advice engine 170 may be that the patient user does not need to seek further medical care. If any of the test results are abnormal and/or the patient user has indicated particular symptoms, the medical advice may indicate the abnormal test results, the medical conditions with which the test results and/or symptoms are associated. Other medical advice that may be developed by the medical advice engine 170 in accordance with combinations of test results and responses will be apparent to those who have skill in the art.

The medical advice engine 170, at block 404, determines whether the test results or the medical advice indicate that the patient user has an abnormal result for a condition that requires consultation with a medical specialist. The medical advice engine 170 uses the regulations engine 160 and the regulations database 106 to determine if federal regulations and/or regulations of the state where the patient user resides require any such abnormal indication to be verbally delivered by a physician user. Additionally, if federal regulations and/or regulations of the state where the patient user resides require physician user to report the abnormal test results to federal and/or state authorities, the medical advice engine 170 generates such report. In particular, an assertion in the regulations database 106 may indicate that an abnormal test result for certain medical conditions, for example an HIV infection, in particular jurisdictions must be delivered by a physician or a counselor. If, at block 404, there is no such abnormal indication, processing proceeds to block 406.

Otherwise, at block 408, the reporting engine 168 generates a medical report in accordance with medical advice that advises the patient user to schedule an in-person consultation with a medical specialist with an explanation why the consultation is advised. The medical advice engine 170, at block 410, may schedule a telephone call between the physician user and the patient user so that the physician user may verbally deliver the contents of the medical report. In some embodiments, the medical advice engine 170, also at block 410, transmits the medical report to the physician system 120. In some embodiments, the medical advice engine 170, at block 410, may use the patient communication engine 150 to facilitate a telephone conference between the physician user and the patient user.

After block 410, the reporting engine 168 makes the medical report generated thereby available to the patient user in a secure section of the patient communication engine 150 and notifies the patient user that such report is available. In one embodiment, the patient communication engine 150 sends an e-mail and/or a text message to the patient system 118. Such message includes a hyperlink to a secure web site hosted by the patient communication engine 150 where the patient user may view the medical report.

If at block 404, the medical advice engine 170 determines that the test results do not indicate a medical condition that requires a consultation with a medical specialist, the medical advice engine 170, at block 406, then determines if the patient user has a physical symptom that is not explained by any abnormal test results for a test associated with the physical symptom in the diagnostics database 102. If so, processing proceeds to block 414. Otherwise processing proceeds to block 416.

At block 414, the reporting engine 168 generates a medical report advising the patient user to schedule an in-person consultation with a primary care physician with an explanation for such recommendation. For example, if the patient user reported a “genital sore” but the test results do not include a abnormal test results for an infection that is associated with a genital sore, the reporting engine 168 indicates in the medical report that the patient consult with a primary care physician because the symptom could not be verified by the tests in the test plan. Processing then proceeds to block 412.

At block 416, the medical advice engine 170 determines if the patient user has an abnormal result that can be addressed by a primary care physician. If so, processing proceeds to block 418, otherwise, processing proceeds to block 420.

At block 418, the regulations engine 160 determines if the patient user resides in a state that allows treatment via a telehealth consultation. If so the reporting engine 168, at block 422, generates a medical report that includes a recommendation that the patient user schedule either a telehealth consultation or an in-person consultation with a primary care physician and a reason for such recommendation. Thereafter, processing proceeds to block 412. Otherwise, processing proceeds to block 414.

At block 420, the medical advice engine 170 determines if the patient user has normal test results but reported contact with an infected person. If so, processing proceeds to a block 424. Otherwise, the reporting engine 168, at block 426, generates a report that includes advice that the patient user does not need to consult with a physician and an explanation for such advice. After block 426, processing proceeds to block 412.

At block 424, the medical advice engine 170 determines if contact with the infected person warrants treatment without a abnormal test result. Contact between the patient user and a person who has a particular infection may automatically warrant treatment even if there is no abnormal test result that indicates the patient user has become infected. In some cases, such treatment may be specified by regulations of the jurisdiction in which the patient user resides. The medical advice engine 170 may use data stored in the regulations database 106 or diagnostics database 102 to make a determination if treatment is necessary. In some embodiments, the medical advice engine 170 may automatically be programmed to recommend treatment for particular infections. If so processing proceeds to block 428. Otherwise processing proceeds to block 426.

At block 428, the regulations engine 160 determines if the patient user resides in a state that allows treatment via a telehealth consultant without any sort of prior physical exam. If so processing proceeds to block 422. Otherwise, processing proceeds to block 414.

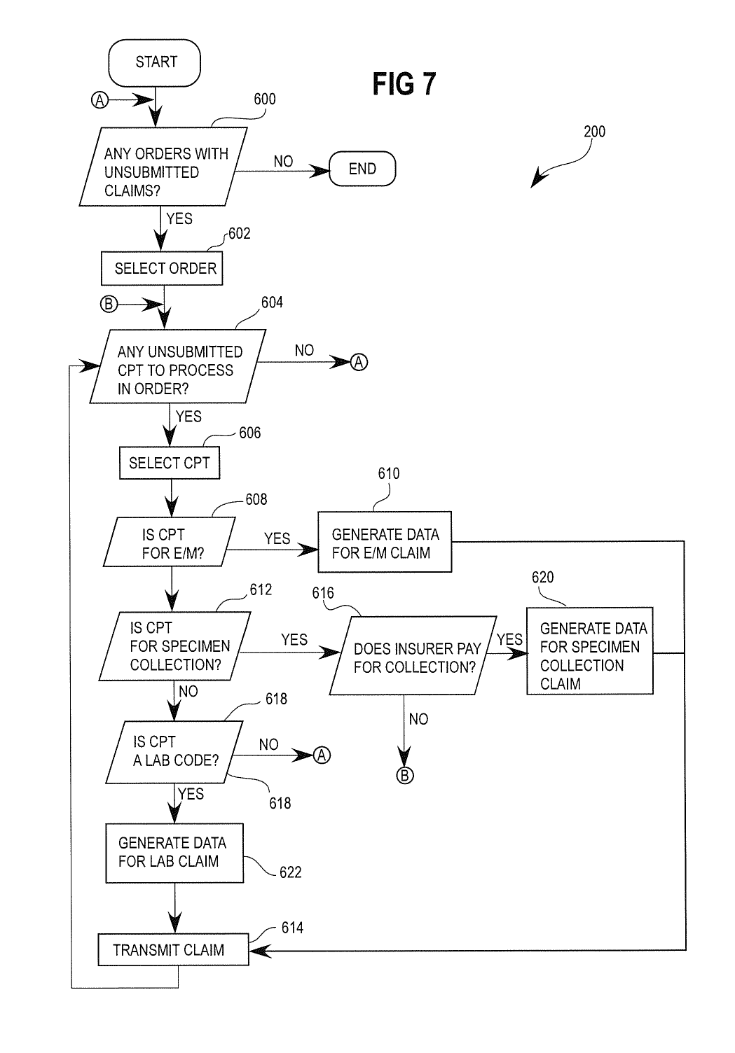

FIG. 7 is a flowchart of the processing undertaken by the HCS 100 at block 312, FIG. 5, to create and submit a claim. At block 600, the insurance engine 154 queries the patient database 107 to determine if there are any billing records for which claims have to be submitted to an insurance provider. In some embodiments, the insurance engine 154 generates such query for billing records associated with the patient user for whom lab test results were received at block 306. In other embodiments, the insurance engine 154 generates such a query for all such billing records. If there are no billing records for which claims have to be submitted, the processing at block 312 exits. Otherwise processing proceeds to block 602.

At block 602, the insurance engine 154 selects a billing record for which a claim needs to be submitted. A block 604 determines if there is a CPT entry in the billing record that has not been processed. If there is no such CPT entry, processing returns to block 600. Otherwise, the insurance engine 154 proceeds to block 606.

At block 606, the insurance engine 154 selects a CPT entry to process. If, at block 608, the insurance engine 154 determines if the CPT code in such entry is associated with evaluation and management (E/M) charge, the insurance engine 154 proceeds to block 610. Otherwise the insurance engine 154 proceeds to block 612.

At block 610, the insurance engine 154 generates data for a claim for the E/M charge. Such data includes an identifier associated with the physician user, a description of the evaluation, a date of service, and other such information apparent to those who have skill in the art. In some embodiments, if the E/M charge is associated with generation of a prescription for a medical test, then the date of service indicates the date when such prescription was generated. Otherwise, the date of service indicates when results were received from the medical testing facility.

After generating the data for the E/M charge at block 610, the insurance engine 154, at block 614, transmits such data to the insurance claim submission and adjudication system 126. Thereafter, the insurance engine 154 returns to the block 604.

At block 612, the insurance engine 154 checks the CPT code in the CPT entry selected at block 604 to determine if such code is associated with a specimen collection charge. If so, processing proceeds to block 616. Otherwise processing proceeds to block 618.

At block 616, the insurance engine 154 determines the particular specimen that was collected and if the insurance provider of the patient user associated with the CPT entry cover the charge associated with collection of the particular specimen. If so, the insurance engine 154, at block 620, generates claim data for the specimen collection and proceeds to block 614 to transmit the claim. Otherwise, the insurance engine 154 returns to block 604.

At block 618, the insurance engine 154 determines if the CPT code is associated with a charge for a medical test. If so, the insurance engine 154 generates claim data for such test, at block 622, and proceeds to block 614 to transmit the generated data.

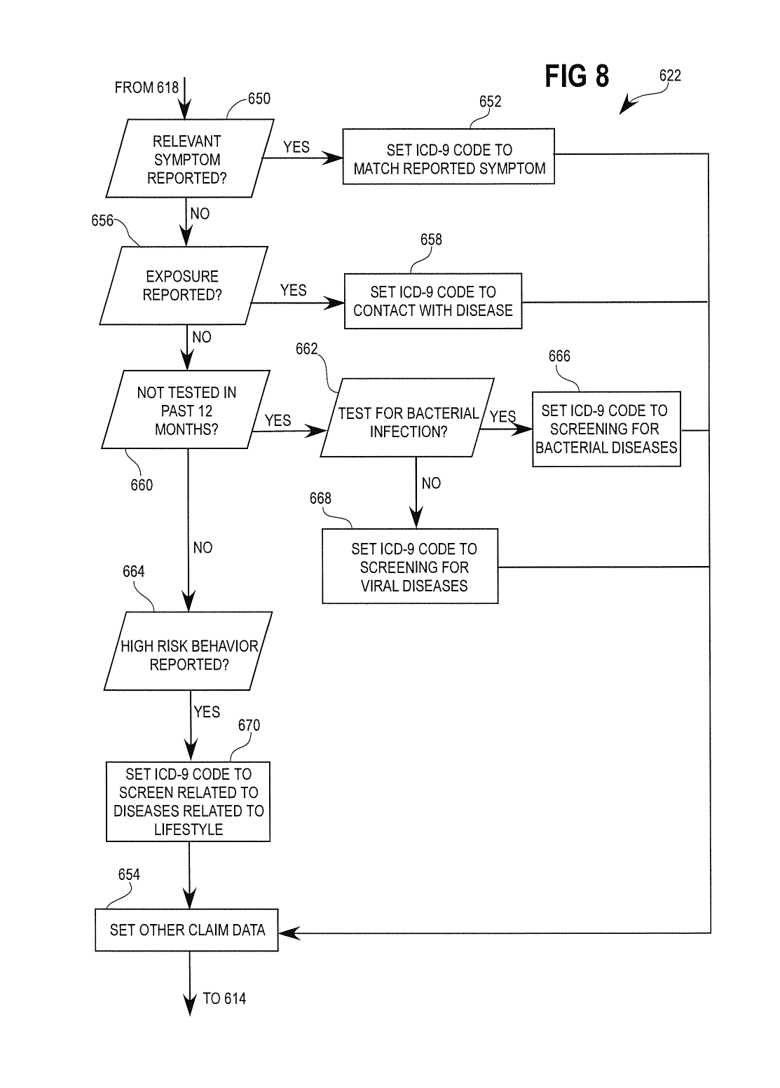

FIG. 8 is a flowchart of the processing undertaken by an exemplary insurance engine 154 to generate claim data for a medical test. Such exemplary insurance engine 154 uses a code in accordance with the Ninth Revision of the International Classification of Diseases (ICD-9 codes) to indicate a reason why a medical test was prescribed and undertaken. It should be apparent to those having skill in the art that the insurance engine 154 may use other classification systems.

Referring to FIG. 8, at block 650, the insurance engine 154 determines if the chief complaint and HPI reported by the patient user who was administered the medical test included a physical symptom. If so, at a block 652, the insurance engine 154 selects an ICD-9 associated with that reported symptom. Thereafter, at block 654, the insurance engine 154 combines the selected ICD-9 code with additional claim information to generate the claim. Such additional claim information may include the date of service when the medical test was administered, charges associated with medical test, an indicator that an outside medical testing facility administered the test, and the like. After block 654, processing continues at block 614 of FIG. 7.

If at block 650, the insurance engine 154 determines that the chief complaint and HPI reported by the patient user do not include a symptom, the insurance engine 154, at block 656, determines if the patient user reported exposure to a medical condition for which the test was prescribed. If so, processing proceeds to block 658. Otherwise processing proceeds to block 660.

At block 658, the insurance engine 154 selects a ICD-9 code associated with contact with disease and proceeds to block 654.

At block 660, the insurance engine 154 checks if more than 12 months have elapsed since an identical medical test was administered to the patient user. If so, processing proceeds to block 662. Otherwise processing proceeds to block 664.

At block 662, the insurance engine 154 checks if the test is for a bacterial infection. If so, the insurance engine 154, at block 664, selects an ICD-9 code for screening for bacterial diseases at block 666 and then proceeds to block 654. Otherwise, the insurance engine 154, at block 668, selects the ICD-9 code for screening for viral diseases and proceeds to block 654.

At block 664, the insurance engine 154 checks if the reason for recommending the medical test was because the patient user reported a high-risk behavior. If so, processing proceeds to block 670. Otherwise, processing proceeds to block 662.

At block 670, the insurance engine 154 selects an ICD-9 code associated with screening for medical conditions related to lifestyle and then proceeds to block 654.

In some embodiments, an operator at a call center may use the HCS 100 to facilitate communication between the physician user and a prospective patient user or the physician user and a patient user and the HCS 100. For example, prospective patient users and patient users may telephone the operator at the call center. The operator at the call center uses the HCS 100 on behalf of physician users, prospective patient users, and/or patient users and uses the HCS 100 to facilitate communications between such users. In some embodiments, instead of providing a web site, the patient communication engine 150 presents a script used by the call center operator to facilitate this communication.

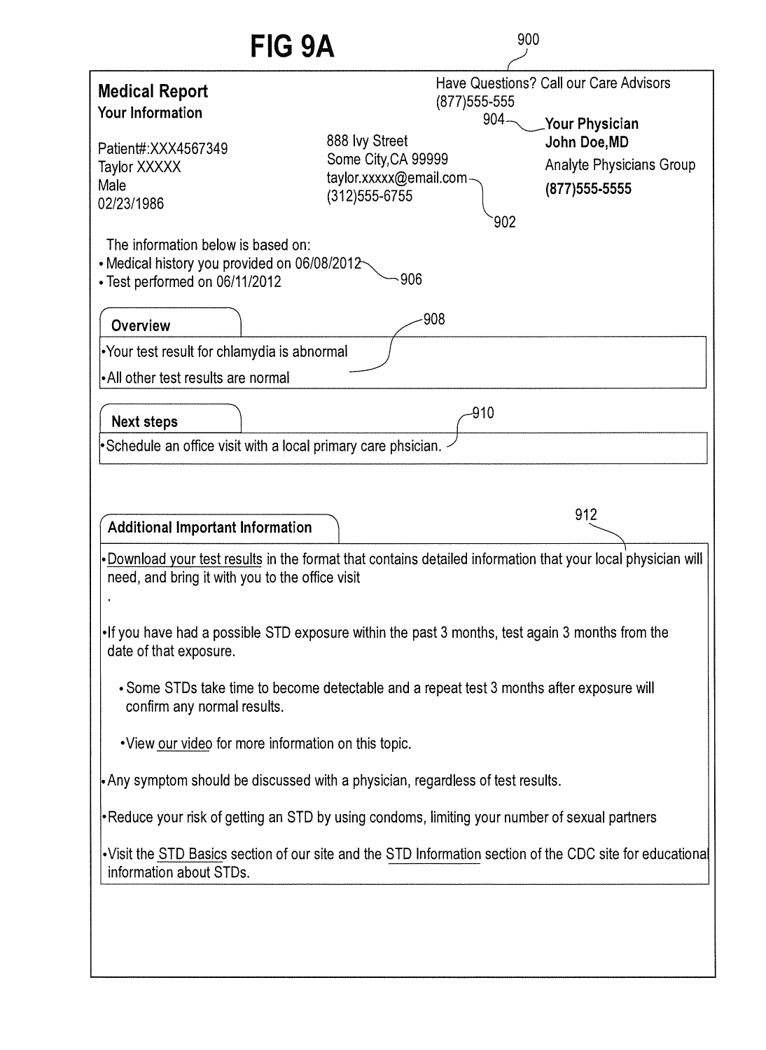

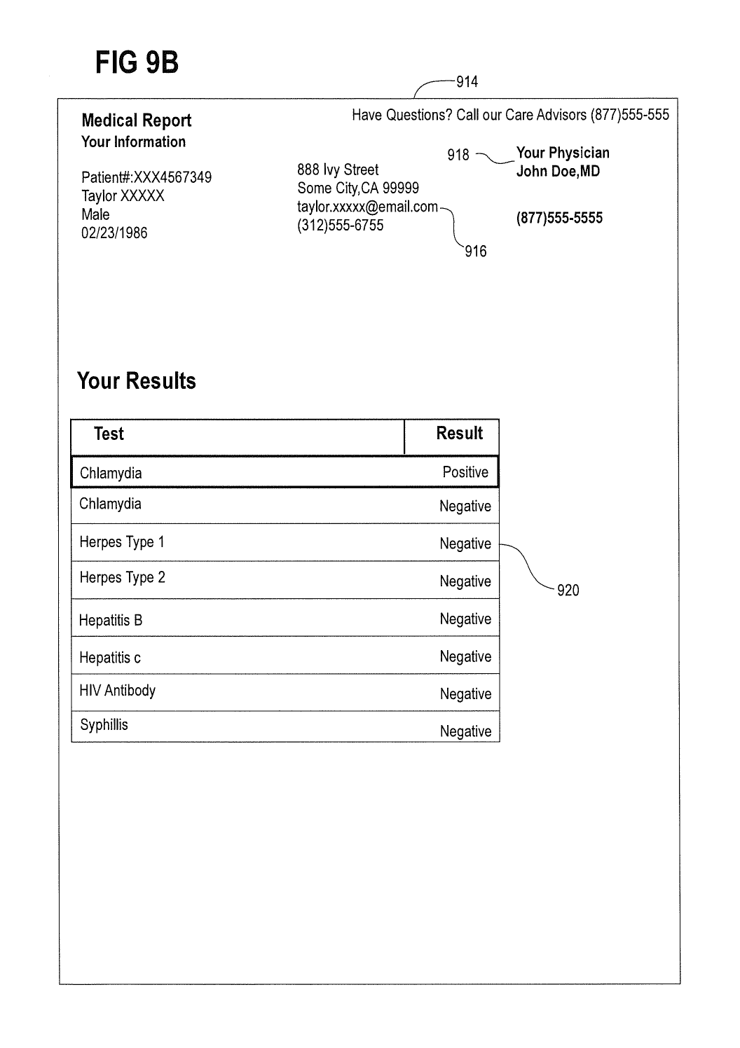

Referring to FIGS. 9A and 9B, a first page 900 of an exemplary medical report includes a section 902 that shows demographic information associated with the patient user and a section 904 that shows information about the physician user associated with the patient user. The first page 900 of the medical report includes in a section 906 that shows when the patient user provided medical information (i.e., provided responses to queries generated by the diagnostics engine 158) and when tests recommended by the diagnostics engine 158 were undertaken. A summary of the medical advice developed by the medical advice engine 170 is recited in a section 908. A section 910 includes follow up advice generated by the medical advice engine 170. The first page 900 of the medical report may include additional information to guide the patient user in a section 912.

A second page 914 of the medical report includes sections 916 and 918 that recite, respectively, the demographic information provided by the patient user via the patient system 118 and information regarding the physician user. A section 920 lists the test in the test panel recommended by the diagnostics engine 158 and whether the results of such tests were normal or abnormal as determined by the result analysis engine 166.

It should be apparent that the pages 900 and 914 of the medical report may include additional or less information and that such pages may be formatted in a different manner.

As seen, an improved method and system that assist a patient and/or a physician in making healthcare-related decisions are provided. In particular, both the individual and the physician are aided in determining if it is medically appropriate for the individual to have a telephonic or in person encounter with a physician. Depending on the circumstances, no real-time encounter with a physician may be needed providing efficiencies for individuals, physicians, insurance payers, and the healthcare system in general. In one example, the particular health insurance plan for the individual is determined. An appropriate patient-physician relationship between the individual and a remotely located physician may then be established. Establishing this patient-physician relationship may take into account regulatory and contractual constraints imposed by the combination of where the individual lives, the health insurance plan of the individual, as well as the medical licenses and health insurance network agreements for a list of remote physicians.

A series of dynamically generated questions about the symptoms and medical history of the individual are answered by the individual and may be presented to the remote physician. The list of follow-up questions changes dynamically as the individual answers the questions. Using the answers to the questions provided by the individual, a medically appropriate panel of diagnostic tests may be recommended. A cost estimate for the entire service that takes into account the specific health insurance plan of the individual, the previous answers to the medical questions, the recommended panel of diagnostic tests, and the specific insurance network agreement of the physicians may be provided.

In certain system embodiments, the individual may have the option to add or remove diagnostic tests from those listed in the panel. The system may prompt the individual to describe whether he or she has reason to add or remove such diagnostic tests. The reasons offered to add a test may be captured and medically-related messages about the risks of removing a test may be provided to the individual. The final recommended diagnostic test panel (i.e., from the remote physician) may be accepted by the system. The diagnostic laboratory test panel for the individual is ensured to be compliant with regulations for the state where the individual resides. Once the diagnostic lab tests are performed, an electronic interpretation of the test results from the diagnostic laboratory that performed the tests may be received for further analysis. The answers to the medical questions provided by the individual and the results of the diagnostic lab tests are both analyzed together. Based on this analysis, a recommendation is made to the individual on whether or not it is medically necessary for he or she to have a telephonic or in-person encounter with a physician, or alternatively, if no further encounter with a physician is needed. The recommendation provided to the individual may include the reasons for the recommendation that take into account the combination of symptoms present with the individual at the time of intake, prior behavior of the individual, history of prior diagnostic testing, and the state where the individual resides.

The HCS 100 executable instructions that may be implemented as a computer program product having instructions stored in a non-transitory computer-readable storage medium associated therewith and which, when executed by a processing module of an electronic system, direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that receiving and transmitting of data as used in this document means that two or more systems, engines, databases, devices, components, modules, or sub-modules are capable of communicating with each other via signals that travel over some type of signal path. The signals may be communication, power, data, or energy signals, which may communicate information, power, or energy from a first system, engine, database, device, component, module, or sub-module to a second system, engine, database, device, component, module, or sub-module along a signal path between the first and second system, engine, database, device, component, module, or sub-module. The signal paths may include physical, electrical, magnetic, electromagnetic, electrochemical, optical, wired, or wireless connections. The signal paths may also include additional systems, engines, databases, devices, components, modules, or sub-modules between the first and second system, device, component, module, or sub-module.

### INDUSTRIAL APPLICABILITY

Numerous modifications to the embodiments disclosed herein will be apparent to those skilled in the art in view of the foregoing description. Accordingly, this description is to be construed as illustrative only and is presented for the purpose of enabling those skilled in the art to make and use the disclosed embodiments and to teach the best mode of carrying out same. The exclusive rights to all modifications that come within the scope of the disclosed embodiments are reserved.

We claim:

1. A computer-implemented system for reporting of medical advice, comprising:
a patient communication engine that receives, from a first computing device, demographic information associated with a patient user and a request from the patient user for a recommendation in connection with a medical condition;
a prescription engine that creates a prescription for a test plan associated with the medical condition and transmits the prescription to a second computing device associated with an entity that executes the test plan;
a results analysis engine that receives from the second computing device test results associated with execution of the test plan for the patient user;
a medical advice engine that uses a regulations database to determine a delivery method for communicating the test results to the patient user, wherein the regulations database includes regulations associated with different jurisdictions; and
a reporting engine that generates a medical report in accordance with the delivery method and provides the medical report to the patient communication engine for transmission to the patient user.

2. The system of claim 1, wherein the medical report comprises (a) a summary of the test results for posting to a web site accessible by the patient user if the delivery method indicates the test results may be communicated directly to the patient user, or (b) information advising the patient user to schedule an appointment for a telehealth consultation or with a physician if the delivery method indicates the test results may not be communicated directly to the patient user.

3. The system of claim 1, further comprising a physicians engine that queries a physicians database and the regulations database to identify a physician in accordance with at least one of the demographic information, the request, and insurance information received from the first computing device, wherein the physicians database includes information regarding physicians.

4. The system of claim 3, wherein the medical advice engine schedules an appointment between the patient user and the physician in accordance with the delivery method.

5. The system of claim 4, wherein the medical advice engine further transmits the medical report to a third computing device associated with the physician.

6. The system of claim 1, wherein the results analysis engine receives raw test result data from the second computing device and uses a diagnostic database to develop condition level test data from the raw test result data, wherein the diagnostic database has stored therein information regarding different medical conditions.

7. The system of claim 6, wherein the raw test results data are received in accordance with the HL7 standard.

8. The system of claim 6, wherein the results analysis engine aggregates the raw test results data into condition groups and classifies the test results with each condition group as being normal or abnormal.

9. The system of claim 8, wherein the patient communication engine further stores the medical report in a secure database, and generates an electronic message addressed to the patient user, wherein the electronic message includes instructions for accessing the medical report.

10. The system of claim 1, wherein the medical condition is related to a sexually transmitted disease or infection.

11. A computer-implemented method for reporting of medical advice, comprising:
receiving, from a first computing device, demographic information associated with a patient user and a request from the patient user for a recommendation in connection with a medical condition;
creating a prescription for a test plan associated with the medical condition;
transmitting the prescription to a second computing device associated with an entity that executes the test plan;
receiving from the second computing device test results associated with execution of the test plan for the patient user;
determining, using a regulations database, a delivery method for communicating the test results to the patient user, wherein the regulations database includes regulations associated with different jurisdictions; and
generating a medical report in accordance with the delivery method and transmitting the medical report to the patient user.

12. The method of claim 11, wherein the medical report comprises (a) a summary of the test results for posting to a web site accessible by the patient user if the delivery method indicates the test results may be communicated directly to the patient user, or (b) information advising the patient user to schedule an appointment for a telehealth consultation or with a physician if the delivery method indicates the test results may not be communicated directly to the patient user.

13. The method of claim 11, further comprising using a physicians database and the regulations database to identify a physician in accordance with at least one of the demographic information, the request, and insurance information received from the first computing device, wherein the physicians database includes information regarding physicians.

14. The method of claim 13, further comprising scheduling an appointment between the patient user and the physician in accordance with the delivery method.

15. The method of claim 14, further comprising transmitting the medical report to a third computing device associated with the physician.

16. The method of claim 11, further comprising receiving raw test result data from the second computing device, and using a diagnostic database to develop condition level test data from the raw test result data, wherein the diagnostic database has stored therein information regarding different medical conditions.

17. The method of claim 16, wherein receiving the raw test results data comprises receiving data in accordance with the HL7 standard.

18. The method of claim 16, wherein generating the medical report comprises aggregating the raw test result data into condition groups and classifying the test results with each condition group as being normal or abnormal.

19. The method of claim 18, further comprising storing the medical report in a secure database, and generating and transmitting an electronic message addressed to the patient user, wherein the electronic message includes instructions for accessing the medical report.

20. The method of claim 11, wherein the medical condition is related to a sexually transmitted disease or infection.
